(19) United States
(12) Patent Application Publication
(10) Pub. No.: US 2026/0243512 A1
(43) Pub. Date: Aug. 20, 2026

(54) SYSTEMS AND METHODS FOR PRE-CONDITIONING FROZEN BULK IN DYNAMIC BULK FREEZE DRYING

(71) Applicant: Pfizer Inc., New York, NY (US)

(72) Inventors: Bernhard LUY, Freiburg (DE); Matthias PLITZKO, Neuenburg (DE)

(21) Appl. No.: 19/161,341

(22) PCT Filed: Feb. 27, 2024
(86) PCT No.: PCT/IB2024/051852

§ 371 Date: Sep. 2, 2025

Related U.S. Application Data
(60) Provisional application No. 63/488,196, filed on Mar. 3, 2023.

(51) Int. Cl. F26B 5/06

(52) U.S. Cl. CPC F26B 5/06

(57) ABSTRACT

The present disclosure includes systems and methods for producing freeze-dried particles, such as in a continuous lyophilization process. In some aspects, the system (100) can include a spray freezing vessel (104) configured to freeze liquid droplets to form bulk material, one or more pre-conditioning vessels (108a-108c) configured to receive bulk material from the spray freezing vessel (104), and a freeze drying vessel (112) configured to receive the bulk material from the pre-conditioning vessel(s) (108a-108c) and to freeze-dry the bulk material therein. Each of the pre-conditioning vessel(s) (108a-108c) can be coupled to a vacuum source (156) and include a container, such as a rotary drum (132), controllable to move while bulk material is in the pre-conditioning vessel (108a-108c).

### TECHNICAL FIELD

The present application relates generally to bulk freeze drying. More specifically, the present disclosure relates to systems and methods for pre-conditioning frozen bulk material in a dynamic bulk freeze drying system.

### BACKGROUND

Freeze drying, also known as lyophilization or cryodesiccation, is a process that removes a solvent or suspension medium from a product. The solvent or suspension medium may be water, though others may be used, such as alcohol. Freeze drying is particularly useful in the pharmaceutical industry, as the integrity of the product is preserved during the freeze drying process and product stability can be guaranteed over relatively long periods of time. In pharmaceuticals, the freeze dried product is ordinarily, but not necessarily, a biological substance. In a freeze drying process for removing water, the water in the product is frozen to form ice and, under low vacuum conditions in a process chamber, the ice is sublimed into the vapor/gas phase.

The freeze drying of frozen bulk material can be performed by conventional shelf-type freeze dryers under static conditions utilizing lyo cakes, or by using dynamic bulk freeze drying processes where the bulk product is kept in motion, such as in a rotating drum or by vibrating shelves or belt driven systems. The bulk freeze drying process can be a batch process or a continuous process. In batch lyophilization, the bulk material is lyophilized in set quantities (or “batches”) at one time, with one batch being processed before the next batch can be begin. In continuous lyophilization, the bulk material is processed with few, brief, or no breaks between phases and without manual intervention. An example of such a continuous process is described in U.S. Pat. App. No. US 2018/0120027. However, there are several issues that arise with the continuous lyophilization process that have prevented the continuous lyophilization process from being widely accepted.

### SUMMARY

The present disclosure provides apparatuses, systems, and methods for improving the flow properties of spray frozen bulk material in a dynamic bulk freeze drying process. Such improvements can be applied to both batch and continuous lyophilization processes to provide enhanced process conditions. To illustrate, in dynamic bulk freeze drying processes a spray freezing step is utilized to freeze a liquid product into droplets that are delivered to a freeze drying step. However, certain aspects of the lyophilization processes can result in reduced flowability during the drying stage. To illustrate, significant condensation of water vapors can occur during the spray freezing process based on the large temperature difference between the liquid droplet (e.g., 2 to 25 degrees Celsius (° C.)) and the temperature of the surrounding process gas (e.g., −70 to −170° C.). This condensation, or fog, can deposit on the inner surface of the spray freezing chamber and freeze to form small ice particles, similar to snow flakes, which transfer with the frozen droplets into subsequent process steps. When these fine ice crystals are mixed with the frozen droplets, the ice crystals act as flow inhibitors, obstructing the rolling effect the round frozen particles would normally have. Recondensation of water vapor and other mechanisms can also contribute to reduction in flowability. Thus, the flow properties of the bulk material can be poor, similar to wet snow, and controlling the motion of the bulk product can be difficult. For example, it has been discovered that in drum rotation the bulk material can stick to the wall until a high degree of inversion is reached, at which point a large chuck of bulk material falls down uncontrolled. This can result in bulk material contacting unintended components (e.g., heater), bulk material falling out of the drum, unwanted product accumulation, clogging of ducts, which prevent later product transfer, and other disadvantageous properties.

The present systems are configured to enhance flow properties of the bulk material in the dynamic bulk freeze drying process. In some aspects of the present disclosure, the present systems are configured for continuously freeze drying a bulk product and may include one or more pre-conditioning vessels configured to receive bulk material from a spray freezing vessel, and a freeze drying vessel configured to: receive the bulk material from the pre-conditioning vessel(s) and freeze-dry the bulk material (e.g., frozen product) therein. The pre-conditioning vessel(s) can be configured to remove ice particles from the bulk material and improve the flow conditions of that bulk material before freeze-drying.

In a broad respect, the present systems include a pre-conditioner configured for use in a dynamic freeze drying process. The pre-conditioner can be used to enhance flowability of a material in a separate location, or the same location, from where the freeze drying takes place. One example of such a pre-conditioner is one that includes a rotatable drum. In some aspects, the pre-conditioner (e.g., pre-conditioning vessel) is sealingly attached to one or more other components of the dynamic freeze drying process such that an interior of the pre-conditioner can be operated at the same or a different pressure than an interior of the other components.

Some of the present systems can include a spray freezing vessel configured to freeze liquid droplets to form bulk material, one or more pre-conditioning vessels configured to receive bulk material from the spray freezing vessel, and a freeze drying vessel configured to receive the bulk material from the pre-conditioning vessel(s) and to freeze-dry the bulk material therein. In some aspects, each of the pre-conditioning vessel(s) can be coupled to a vacuum source. Each of the pre-conditioning vessel(s) can include a container controllable to move while bulk material is in the pre-conditioning vessel and a heater configured to increase or decrease a temperature of the container. In some configurations, the heater may adjust a temperature of a surface of the container. The heater may be controllable to achieve the aforementioned temperature increase, temperature decrease, or temperature adjustment, and may be controlled by one of the present controllers.

In some aspects, each pre-conditioning vessel is coupled to the spray freezing vessel via a transfer section that can be opened or closed to allow or not allow bulk material to travel from the spray freezing vessel to that pre-conditioning vessel. In some configurations, the container is a rotary drum. In some such aspects, each pre-conditioning vessel may include a vacuum chamber coupled to the vacuum source and a heater positioned outside the drum and at least partially inside the vacuum chamber. In such configurations, the drum of each pre-conditioning vessel is positioned inside the vacuum chamber of that pre-conditioning vessel and can be controllable to move in a pendular mode while bulk material is in the drum. The pendular mode does not include a complete rotation of the drum. In some of the configurations described herein, the drum of each pre-conditioning vessel may be controllable to rotate to discharge bulk material from that drum.

In some aspects, the freeze drying vessel may be coupled to a second vacuum source. The freeze drying vessel can include a freeze drying vessel drum configured to receive bulk material from each pre-conditioning vessel and a freeze drying vessel heater configured to transfer heat to or from bulk material within the freeze drying vessel drum. In some of the present system, the one or more pre-conditioning vessel(s) include a first pre-conditioning vessel configured to receive bulk material from the spray freezing vessel and a second pre-conditioning vessel configured to receive bulk material from the spray freezing vessel. In some such configurations, the system may include one or more transfer valve(s) coupled to the spray freezing vessel that are configurable in a first position in which bulk material is configured to flow from the spray freezing vessel to the first pre-conditioning vessel and a second position in which bulk material is configured to flow from the spray freezing vessel to the second pre-conditioning vessel. Some aspects may include a third or fourth pre-conditioning vessel.

Some aspects of the present systems can include a controller that can execute instructions that cause the controller to perform operations. The controller can include a processor and a memory that is coupled to the processor and configured to store instructions that, when executed by the processor, cause the controller to perform operations. Some of the operations can include determining a time period in which bulk material is within a first pre-conditioning vessel of the one or more pre-conditioning vessel(s) and based on the time period meeting a first threshold, actuating the first pre-conditioning vessel to transfer bulk material to the freeze drying vessel. Additionally, or alternatively, some of the operations can include actuating a liquid source to deliver the liquid droplets to the spray freezing vessel and actuating the one or more transfer valve(s) to the first position to deliver a first portion of the bulk material to the first pre-conditioning vessel. In response to a condition, such as receiving an input, the operations can include actuating the one or more transfer valve(s) to the second position to deliver a second portion of the bulk material to the second pre-conditioning vessel, sealing the first pre-conditioning vessel from the spray freezing vessel, operating the first pre-conditioning vessel in a first state to remove ice particles from the first portion of the bulk material, or a combination thereof.

In some aspects, the operations can further include determining a duration of the first pre-conditioning vessel operating in the first state and comparing the duration to one or more stored values. As an example, based on the duration meeting a first threshold, the operations can include actuating the first pre-conditioning vessel to discharge the first portion of the bulk material to the freeze drying vessel, actuating the one or more transfer valve(s) to the first position to deliver a third portion of the bulk material to the first pre-conditioning vessel, operating the second pre-conditioning vessel in the first state to remove ice particles from the second portion of the bulk material, or a combination thereof. In some aspects, the operations can include actuating the vacuum source to decrease a pressure in the first pre-conditioning vessel to less than 50 microbar and actuate the drum of the first pre-conditioning vessel to operate in a pendular mode.

In a broad respect, the present methods can include producing freeze-dried particles aseptically. Stated differently, the present methods can include producing freeze-dried particles under aseptic conditions. The methods can include pre-conditioning a bulk material in a step before freeze drying the material. In some aspects, the method may include forming a bulk material having frozen pellets and ice particles, pre-conditioning the bulk material, and, subsequently, freeze drying the bulk material. In a particular example, the method can include forming bulk material in a spray freezing vessel, transferring a first portion of the bulk material to a first pre-conditioning vessel, and operating the first pre-conditioning vessel in a first state to remove ice particles from the first portion of the bulk material. Some methods may further include transferring the first portion of the bulk material from the first pre-conditioning vessel to a freeze drying vessel and operating the freeze drying vessel in a second state to freeze-dry the first portion of the bulk material. In at least some of the present methods, the first pre-conditioning vessel can be in constant motion while the first portion of the frozen bulk material is disposed therein. Thus, in at least some of the present methods, at least some (up to all) of the first portion of the frozen bulk material can be in constant motion while it is in the first pre-conditioning vessel.

In some aspects, operating the first pre-conditioning vessel in the first state may include sealing the first pre-conditioning vessel from the spray freezing vessel, operating the first pre-conditioning vessel under a vacuum, operating a drum of the first pre-conditioning vessel in a pendular mode, or a combination thereof. Some of the present methods can include transferring a second portion of the bulk material to a second pre-conditioning vessel, operating the second pre-conditioning vessel in a third state to remove ice particles from the second portion of the bulk material, transferring the second portion of the bulk material from the second pre-conditioning vessel to the freeze drying vessel, operating the freeze drying vessel in the second state to freeze-dry the second portion of the bulk material, or a combination thereof. In some aspects, operating the first pre-conditioning vessel in the first state and the transferring the second portion of the bulk material to the second pre-conditioning vessel occur concurrently.

In some methods, subsequent to the transfer of the first portion of the bulk material from the first pre-conditioning vessel to the freeze drying vessel and the transfer of the second portion of the bulk material to the second pre-conditioning vessel, the method can further include the steps of transferring a third portion of the bulk material to the first pre-conditioning vessel, operating the first pre-conditioning vessel in the first state to remove ice particles from the third portion of the bulk material, transferring the third portion of the bulk material from the first pre-conditioning vessel to the freeze drying vessel, operating the freeze drying vessel to freeze-dry the third portion of the bulk material, or a combination thereof. In some aspects, the transferring the first portion of the bulk material from the first pre-conditioning vessel to the freeze drying vessel is performed during a first time period and transferring the second portion of the bulk material from the second pre-conditioning vessel to the freeze drying vessel is performed during a second time period. The second time period can be shortly after the first time period, such as within 1, 2, 3, 5, 7, 10, or 15 minutes of the expiration of the first time period or, in other configurations, can at least partially overlap with the first time period. In some aspects, operation of the first pre-conditioning vessel in the first state is performed for twenty to sixty minutes. In some of the methods described herein, an amount of ice particles in the first portion of the bulk material is reduced by fifty percent by the operating the first pre-conditioning vessel in the first state.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” or “approximately” is defined as largely but not necessarily wholly what is specified (and includes what is specified; e.g., substantially 90 degrees includes 90 degrees and substantially parallel includes parallel), as understood by a person of ordinary skill in the art. In any disclosed configuration, the term “substantially” may be substituted with “within [a percentage] of” what is specified, where the percentage includes . 1, 1, 5, and 10 percent.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, something that “comprises,” “has,” “includes,” or “contains” one or more elements possesses those one or more elements, but is not limited to possessing only those one or more elements. Likewise, a method that “comprises,” “has,” “includes,” or “contains” one or more steps possesses those one or more steps, but is not limited to possessing only those one or more steps.

Furthermore, all numerical ranges herein should be understood to include all integers, whole or fractions, within the range, inclusive of the ends of the ranges. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth. Additionally, the use of between when describing two endpoint of a numerical range should be understood to include those endpoints. For example, a disclosure of between 1 to 10 should be construed as supporting a range including 1 and including 10.

Herein, “or” is inclusive and not exclusive, unless expressly indicated otherwise or indicated otherwise by context, and can have the same meaning as “and/or.” Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Any configuration of any of the apparatuses, systems, and methods can consist of or consist essentially of—rather than comprise/include/have—any of the described steps, elements, or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one configuration may be applied to other configurations, even though not described or illustrated, unless expressly prohibited by this disclosure or the nature of the configurations. Further, an apparatus or system that is configured in a certain way is configured in at least that way, but it can also be configured in other ways than those specifically described. Some details associated with the configurations described above and others are described below.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 is a schematic view of an example of a freeze drying system of some embodiments of the present disclosure.

FIG. 2 is a schematic view of an example of a pre-conditioning vessel of one of the present freeze drying systems.

FIG. 3A is a schematic view of another example of a freeze drying system of the present disclosure having a plurality of pre-conditioning vessels.

FIGS. 3B and 3C are enlarged views of a transfer flap of the freeze drying system of FIG. 3A in a first state and a second state, respectively.

FIG. 4 illustrates a flow diagram of an example of a method of producing of freeze-dried particles.

FIG. 5 illustrates another flow diagram of an example of a method of producing of freeze-dried particles.

### DETAILED DESCRIPTION

The following description concerns the use of a pre-conditioning vessel that includes a rotary drum for the container configured to receive and move frozen bulk material during the present pre-conditioning. However, those of ordinary skill in the art should understand that the present pre-conditioning processes can be applied to pre-conditioning vessels with other containers, such as those that include vibrating shelves or belt dryers, as well as other vessels with non-rotating containers (e.g., those a container suitable or otherwise configured for stirring or tumbling frozen bulk material therein, or the like), and the same or similar benefits should follow. Additionally, those of ordinary skill in the art should understand that the structures of certain components associated with the rotary drum, such as the heater, valves, transfer sections, or the like, can change based on the specific type of container utilized for the pre-conditioning processes, described herein.

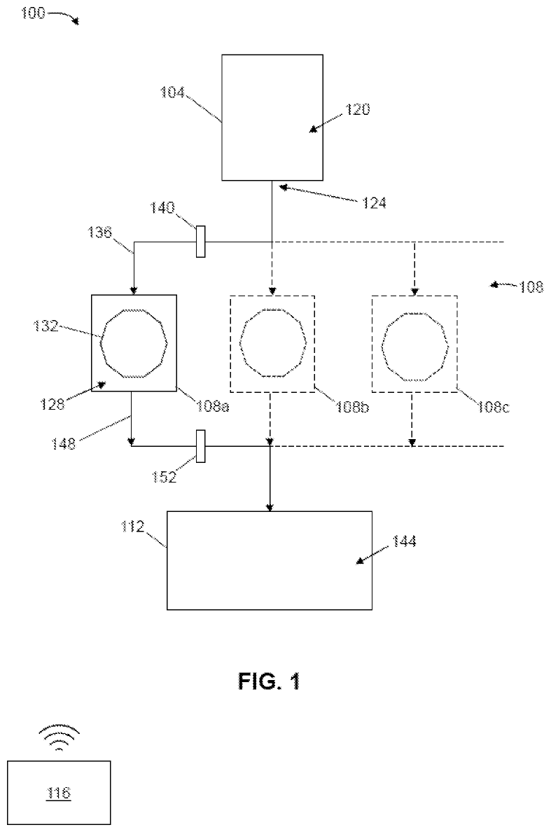

Referring to FIG. 1, a freeze drying system 100, for freeze drying a bulk product, is shown. As depicted, system 100 may include a spray freezing vessel 104, one or more pre-conditioning vessel(s) 108, a freeze drying vessel 112, a controller 116, or a combination thereof. System 100 may be configured for batch or continuous lyophilization and is configured to improve handling of bulk material during the lyophilization process.

Spray freezing vessel 104 is configured to freeze a liquid product (e.g., a solution and a substrate to be lyophilized). To illustrate, spray freezing vessel 104 may define a chamber 120 configured to receive liquid product (e.g., as liquid droplets) and freeze the product as it moves through the chamber toward an outlet 124. Chamber 120 may be maintained within a temperature range that is sufficient to freeze the product before the droplets reach outlet 124, such as within a range from −40° C. to −160° C. In some configurations, spray freezing vessel 104 can include a spray device (e.g., an atomizer, hydraulic nozzles, two-component nozzles, etc.) that is configured to generate discrete droplets that are then delivered to chamber 120. Due to the temperature difference between the liquid product and the chamber, condensation may occur within chamber 120 and ice crystals or ice particles (not containing the product) can form. These ice particles can be transferred (e.g., to pre-conditioning vessel(s) 108) with the frozen droplets, as bulk material and may exhibit poor flow properties based on the amount of ice particles within the bulk material.

Each pre-conditioning vessel 108 defines a chamber 128 configured to receive bulk material from spray freezing vessel 104 and includes a container, in the form of rotary drum 132, that is controllable to move the bulk material within the pre-conditioning vessel. However, as described herein, other containers (e.g., agitators) or heaters may be utilized to perform the processes described herein. As depicted, system 100 includes three pre-conditioning vessels 108: a first pre-conditioning vessel 108a, a second pre-conditioning vessel 108b, and a third pre-conditioning vessel 108c. However, in other configurations, more (e.g., four or more) or less (e.g., one or two) pre-conditioning vessels may be utilized, as described herein. In some configurations, at least one of the pre-conditioning vessels 108 may include or correspond to a rotating drum freeze dryer, as described in U.S. Pat. No. 9,347,707, which is incorporated by reference herein in its entirety, except that the pre-conditioning vessels 108 are controllable to remove ice particles from the bulk material without freeze drying the product. To illustrate, each pre-conditioning vessels 108 may be operable to decrease a concentration of ice crystals within the bulk material, and, consequently, increase a concentration of frozen product (e.g., frozen pellets) within the bulk material.

Each pre-conditioning vessel 108 can receive product from spray freezing vessel 104 directly or indirectly. For example, each pre-conditioning vessel 108 may be coupled to spray freezing vessel 104 via a first transfer section 136 to facilitate transfer of the bulk material. First transfer section 136 can include a tube (e.g., a double-walled tube) defining a conduit for conveying the bulk material and may include other suitable components as known in the art (e.g., cooling circuitry, sensor circuitry, or access points for cleaning/sterilization). As depicted herein, first transfer section 136 is arranged to accomplish a transfer of the product via gravity; however, in other configurations, additional or alternative equipment (e.g., a conveyor component, vibrating component, etc.) can be provided. In some configurations, first transfer section 136 can be opened or closed to allow or not allow bulk material to travel from the spray freezing vessel to that pre-conditioning vessel. To illustrate, as shown in FIG. 1, a first transfer valve 140 can be disposed on first transfer section 136 between spray freezing vessel 104 and first pre-conditioning vessel 108a.

First transfer valve 140 is moveable between: an open configuration in which bulk material is configured to flow from spray freezing vessel 104 to first pre-conditioning vessel 108a and a closed configuration in which bulk material is prevented from flowing from the spray freezing vessel to the first pre-conditioning vessel. First transfer valve 140 may include, but is not limited to, a flap gate, a lid, or a valve, such as a suitable butterfly valve, a squeeze valve, a knife gate valve, or the like. In some such configurations, first transfer valve 140 may seal first pre-conditioning vessel 108a from spray freezing vessel 104 while the first transfer valve is in the closed configuration. In this way and others, first pre-conditioning vessel 108a may operate at different atmospheric conditions than spray freezing vessel 104. Although only a single, first transfer valve 140 is shown in FIG. 1, system 100 can include multiple first transfer valves positioned between spray freezing vessel 104 and pre-conditioning vessel(s) 108 (e.g., a first transfer valve between the spray freezing vessel and each pre-conditioning vessel, multiple first transfer valves between the spray freezing vessel and a single, pre-conditioning vessel, or both).

Freeze drying vessel 112 defines a chamber 144 that is configured to receive the bulk material from pre-conditioning vessel(s) 108 and freeze-dry the bulk material (e.g., frozen product) therein. In some configurations, freeze drying vessel 112 can include an agitator, such as a rotary drum, one or more vibrating shelves, one or more conveyors, or other suitable mechanism to move to bulk material during the freeze drying operation. In some configurations, freeze drying vessel 112 may include or correspond to the rotating drum freeze dryer described in U.S. Pat. No. 9,347,707. As a non-limiting example, freeze drying vessel 112 can include a freeze drying vessel drum (e.g., 132) configured to receive bulk material from each pre-conditioning vessel and a freeze drying vessel heater configured to transfer heat to or from bulk material within the freeze drying vessel drum. However, it should be understood that any suitable freeze dryer may be utilized; especially, freeze dryers that are suitable for continuous lyophilization, as the bulk material received from the pre-conditioning vessel(s) 108 can have improved flow properties compared to the flow properties achievable with traditional systems and methods.

Freeze drying vessel 112 can receive product from each pre-conditioning vessel 108 directly or indirectly. For example, each pre-conditioning vessel 108 may be coupled to freeze drying vessel 112 via a second transfer section 148 that can be opened or closed to allow or not allow bulk material to travel from a respective pre-conditioning vessel to the freeze drying vessel. In some such configurations, a second transfer valve 152 can be disposed on second transfer section 148 between first pre-conditioning vessel 108a and freeze drying vessel 112. Second transfer section 148 and second transfer valve 152 can operate similarly to first transfer section 136 and first transfer valve 140, respectively. In some configurations, freeze drying vessel 112 may include an outlet to deliver the freeze-dried product for further processing, such as to a packaging station, a discharge station, a filling station, or other process equipment.

Controller 116 (e.g., control system) can include a processor and a memory connected to one or more described components or additional sensors, wireless interfaces, input/output (I/O) devices, or other circuitry or network components. Although not shown herein, each sub-component of controller 116 (e.g., processor, memory, and interface, such as communication interface, graphical user interface, or the like) can be illustrated by additional boxes within the box that illustrates the controller. The processor may be a central processing unit (CPU) or other computing circuitry (e.g., a microcontroller, one or more application specific integrated circuits (ASICs), or the like) and may have one or more processing cores. Memory may include read only memory (ROM) devices, random access memory (RAM) devices, one or more hard disk drives (HDDs), flash memory devices, solid state drives (SSDs), other devices configured to store data in a persistent or non-persistent state, or a combination of different memory devices. The memory may be configured to store data associated with the system (e.g., 100), such as one or more measurements transmitted by sensors, one or more thresholds, other historical or predictive data, or a combination thereof. Memory may store instructions that, when executed by the processor, cause the processor to perform the operations described herein. In some configurations, controller 116 can include or be coupled to an interface, such as a network interface or a device interface configured to be communicatively coupled to one or more other devices, like an input/output device (e.g., a touchscreen, a display device, a light emitting diode (LED), a speaker, a microphone, a camera, a keyboard, a computer mouse, another I/O device, or any combination thereof).

Controller 116 can be in electrical communication (e.g., wired or wireless communication) with one or more of the components of system 100 to perform one or more of the operations described herein. For example, the one or more operations may include forming a bulk material in spray freezing vessel 104, transferring the bulk material from the spray freezing vessel to first pre-conditioning vessel 108a and operating the first pre-conditioning vessel to remove ice particles from the bulk material, transferring the bulk material from the first pre-conditioning vessel to freeze drying vessel 112 and operating the freeze drying vessel to freeze-dry the frozen product, or a combination thereof. The one or more operations may also include determining a time period or duration in which bulk material is within the pre-conditioning vessels 108 and actuating one or more components (e.g., valves 140, 152, drum 132, or the like) based on the time period. For example, the operations can include actuating a specific pre-conditioning vessel (e.g., 108a, 108b, 108c) to transfer bulk material to freeze drying vessel 112 based on the time period meeting a first threshold.

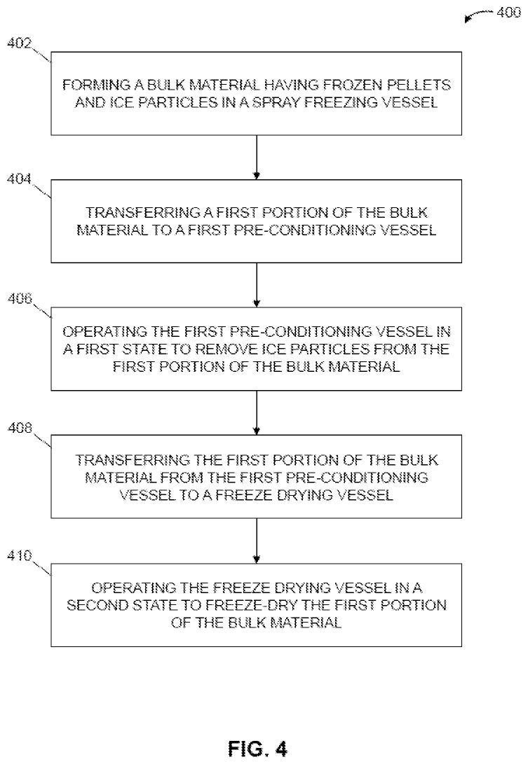

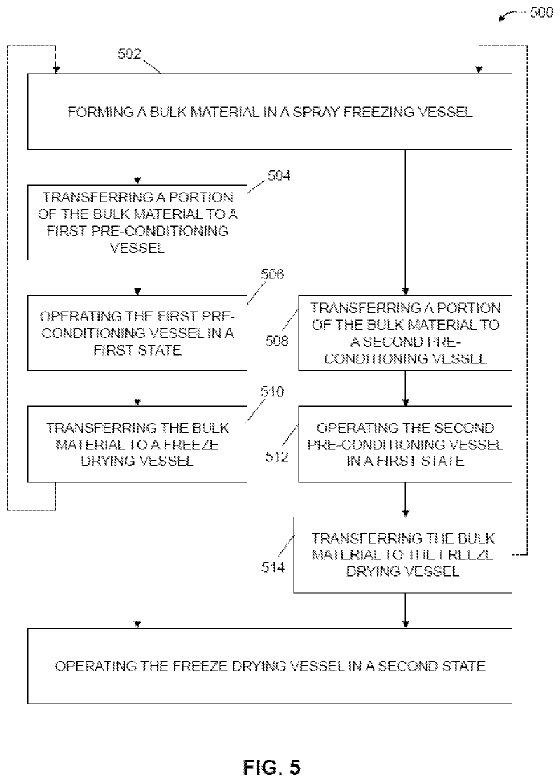

In configurations having multiple pre-conditioning vessels 108, the one or more operations may include operating system 100 in a continuous lyophilization process. As a non-limiting example, the operations can include actuating at least one of first transfer valves 140 to be in a first position in which bulk material is configured to flow from spray freezing vessel 104 to first pre-conditioning vessel 108a and actuating at least one of the first transfer valves to be in a second position in which bulk material is configured to flow from the spray freezing vessel to second pre-conditioning vessel 108b. Additionally, or alternatively, the one or more operations may include actuating at least one of second transfer valves 152 between a first position in which bulk material is configured to flow from first pre-conditioning vessel 108a to freeze drying vessel 112 and a second position in which bulk material is configured to flow from second pre-conditioning vessel 108b to the freeze drying vessel. Additional operations are described in more detail with respect to FIGS. 4 and 5, below.

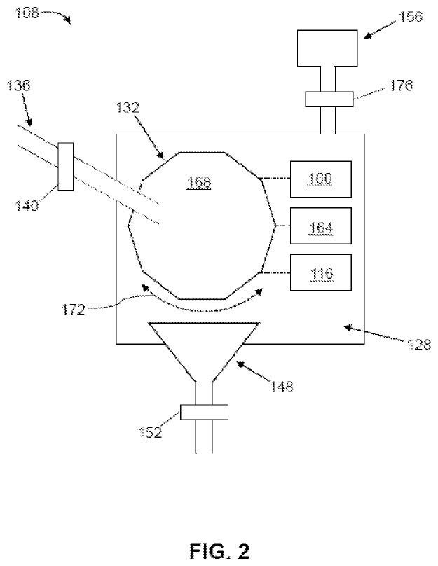

Referring now to FIG. 2, pre-conditioning vessel 108 may include rotary drum 132, heater 160, one or more sensors 164, controller 116, or a combination thereof. Although shown within chamber 128, at least some components of pre-conditioning vessel 108 can be at least partially outside the chamber. Pre-conditioning vessel 108 can include, or be coupled to, first transfer section 136, second transfer section 148, and a vacuum source 156, and, as described further herein, the pre-conditioning vessel is operable in a first state to remove ice particles from the bulk material.

Rotary drum 132 defines an internal volume 168 that is configured to receive bulk material from first transfer section 136 (e.g., via an opening within the drum) and is rotatable while bulk material is within the internal volume to impart motion thereto. As described in more detail in U.S. Pat. No. 9,347,707, drum 132 can be operable to discharge bulk material to second transfer section 148 and can include one or more components configured to enable such operation (e.g., a discharge opening, discharge baffles, inclination means, or the like). As an illustrative example, pre-conditioning vessel 108 can include an outlet that is in communication with second transfer section 148 and configured to receive bulk material discharged from rotary drum 132 while the drum is operating in a discharge mode (e.g., reversed rotation direction, increased inclination angle, or the like). Rotary drum 132 can be configured (e.g., rotary drum 132 may be controlled) to rotate at speeds between zero and two revolutions per minute (rpm), such as from 0.1 to 1 rpm. In some configurations, a rotation angle of rotary drum 132 is limited (e.g., electronically, via controller 116) to operate in a pendular mode. In the pendular mode, rotary drum 132 may be prevented from completing a full rotation (i.e., 360°). In some configurations, rotary drum 132 can be configured (e.g., rotary drum 132 may be controlled) to, while in the pendular mode, travel back and forth (e.g., clockwise and counterclockwise) along an arc 172 that is less than or equal to 270° (e.g., less than or equal to 250, 220, 200, 180, 150, 140, 130, 120, 110, 100, 90, 80, 70, 60 degrees, or less) and greater than or equal to 5°. The pendular mode can be configured (e.g., controlled) such that the back and forth rotation of rotary drum 132 does not discharge bulk material from internal volume 168.

Heater 160 is configured to transfer heat to or from bulk material within rotary drum 132. In some configurations, heater 160, or components thereof, can be positioned outside rotary drum 132 (e.g., internal volume 168) and at least partially inside chamber 128. As an illustrative example, heater 160 can include temperature control circuitry that may comprise tubing for a heating or cooling medium (e.g., silicone oil) or electrical circuitry for electrical heating or cooling, such as via Peltier elements, heating coils, microwave heating, or the like. In some such configurations, the temperature control circuitry may be thermally coupled to the walls of rotary drum 132 (e.g., disposed within a double wall of the drum) and subject to the control of controller 116. In some configurations, heater 160 may not include an infrared radiator. Heater 160 can be configured to operate rotary drum at a target temperature range, such as, for example, from −40 ° C. to −30° C.

Sensor(s) 164 may be coupled to one or more components of pre-conditioning vessel 108 to measure, calculate, or otherwise determine or detect parameters associated with operation of the pre-conditioning vessel, such as temperature, pressure, moisture content, flow characteristics of the bulk material, or the like. In some configurations, sensor 164 may comprise one or more temperature sensors, pressure sensors, humidity sensors, optical sensors (e.g., camera), timers, or the like. Sensor(s) 164 can be in communication with controller 116 and, as an example, may send control signals to the controller to store data created by the sensor(s).

Vacuum source 156 is in fluid communication with chamber 128 of pre-conditioning vessel 108 and configured to generate vacuum conditions within the chamber (e.g., vacuum chamber) and within internal volume 168 of rotary drum 132. In some configurations, vacuum source 156 can include a condenser and a vacuum pump configured to reduce a pressure within chamber 128 to a target pressure range (e.g., from 10 microbar (μbar) up to 200 μbar). In configurations where vacuum source 156 includes a condenser, the condenser may be operated at temperatures below −50° C. As depicted in FIG. 2, a vacuum valve 176 can selectively separate chamber 128 from vacuum source 156 such that the pressure within the chamber can be controlled independent of the actuation of a vacuum pump. In other words, a vacuum pump of vacuum source 156 can remain operational and vacuum valve 176 can be actuated to adjust atmospheric conditions within chamber 128.

First and second transfer sections 136, 148 are configured to transfer bulk material between pre-conditioning vessel 108, as described above with reference to FIG. 1. Each of first transfer section 136 and second transfer section 148, can be selectively sealed from chamber 128 of pre-conditioning vessel 108 (e.g., via valves 140, 152, respectively) to enable operations at sub-atmospheric pressure within the chamber. As described, a “seal” or “sealing” should be understood as “leakage-free” for gas, liquids, and solids, to be maintained for pressure differences of, for example, atmospheric conditions on one side and vacuum conditions (e.g., 10 millibar or less) on the other side. Each of first and second transfer sections 136, 148 can be coupled to a pre-conditioning vessel 108 (e.g., to a vessel wall) to allow for the protection of sterility or containment at the transition from the respective transfer sections and the pre-conditioning vessel. Such coupling can be permanent (e.g., via welding) or semi-permanent (e.g., via screwing or bolting), which are intended to be permanent during production runs, cleaning, sterilization, etc., but which can be disassembled for purposes of inspection, revision, validation, etc. Sealing technologies that may be applied in conjunction with the aforementioned techniques in order to provide the prerequisite for “closed conditions” (sterile or containment conditions) include, but are not limited to, flat seals or gaskets, flange connections, and the like. Any sealing material should be absorption-resistant and should withstand low temperatures in order to avoid embrittling or attrition with risk of product pollution resulting therefrom. Adhesive bonding may also be employed as long as any adhesive is emission-free.

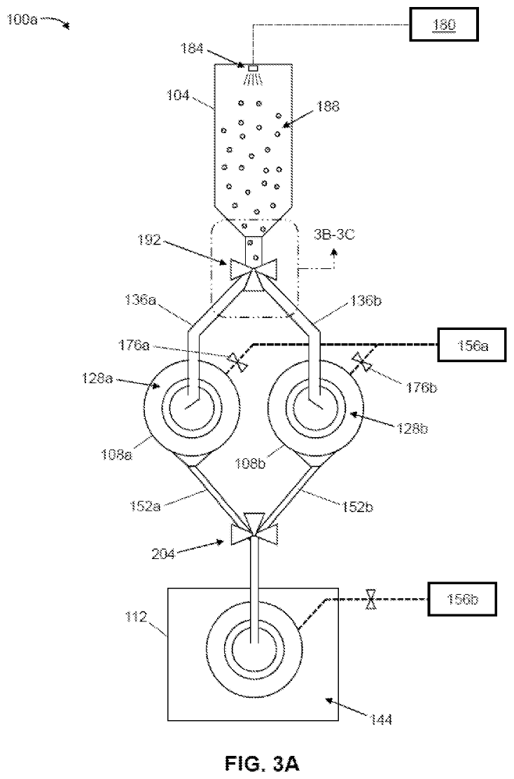

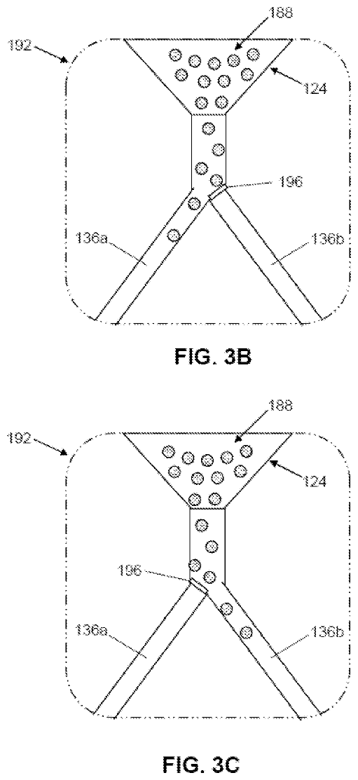

Referring now to FIG. 3A, shown is an example of system 100 in another configuration. System 100a may be utilized to carry out a freeze drying process, such as the freeze-drying of pharmaceutical compositions, biological materials such as proteins, enzymes, microorganisms, or any thermo- or hydrolysis-sensitive materials. As depicted, system 100a can include spray freezing vessel 104, first pre-conditioning vessel 108a, second pre-conditioning vessel 108b, and freeze drying vessel 112. In system 100a, components that are similar, such as in structure or function, to components discussed with reference to FIGS. 1 and 2 are labeled with the same reference numerals and a new numeral suffix: “a” or “b.” These similar components of system 100a may include or correspond to the matching components of system 100.

Spray freezing vessel 104 can be in communication with a liquid source 180 that is configured to deliver liquid product to an atomizer 184 to generate a plurality of droplets 188 (e.g., liquid droplets) within chamber 120 of the spray freezing vessel 104. Spray freezing vessel 104 is configured to freeze the liquid droplets as they fall through chamber 120 to form frozen droplets having diameters that are less than 1500 micrometers (μm). In some such configurations, chamber 120 can be operated at atmospheric conditions and in a temperature range from approximately −50° C. to −190° C. The frozen droplets 188 can be guided to outlet 124 to be transferred to first and second pre-conditioning vessel 108a, 108b. As depicted in FIG. 3A, outlet 124 can include or be coupled to a transfer flap 192 that is configured to direct droplets 188 between the first and second pre-conditioning vessel 108a, 108b. For example, transfer flap 192 can be moveable (e.g., controlled to move) between a first position in which droplets 188 are directed to a first passage 136a of first transfer section 136 and a second position in which the droplets are directed to a second passage 136b of the first transfer section. Although described with respect to transfer flap 192, other configurations of system 100a can utilize one or more valves (e.g., 140) to be configurable in the first position and the second position.

Referring now to FIGS. 3B and 3C, shown is an illustrative example of transfer flap 192 in the first position and second position, respectively. In the depicted configuration, transfer flap 192 includes a flap body 196 that is moveable to obstruct an opening of first passage 136a (FIG. 3B) and second passage 136b (FIG. 3A). Flap body 196 may be hingedly coupled to move between the first and second positions or, in other configurations, can be moveable in other suitable manners (e.g., rotation, translation, or the like) to perform the functions described herein. In some configurations, flap body 196 can be configured to seal the passages (e.g., 136a, 136b) of first transfer section 136 from chamber 120 of spray freezing vessel 104. For example, as shown in FIG. 3B, transfer flap 192 is configured in the first position to guide bulk material (e.g., droplets 188 and any accumulated ice particles) to first passage 136a and create a seal between chamber 120 of spray freezing vessel 104 and second passage 136b. As shown in FIG. 3B, transfer flap 192 is configured in the second position to guide bulk material to second passage 136b and create a seal between chamber 120 of spray freezing vessel 104 and first passage 136a. Additionally, or alternatively, one or more valves (e.g., 140) can be coupled to the passages (e.g., 136a, 136b) of first transfer section 136 to selectively seal chamber 120 of spray freezing vessel 104 from the passages.

Referring back to FIG. 3A, first passage 136a is coupled to first pre-conditioning vessel 108a and configured to transfer bulk material to the first pre-conditioning vessel (e.g., to internal volume 168 of drum 132) and second passage 136b is coupled to second pre-conditioning vessel 108b and configured to transfer bulk material to the second pre-conditioning vessel. Each of first and second pre-conditioning vessels 108a, 108b are coupled to vacuum source 156a. In some configurations, first pre-conditioning vessel 108a includes a first vacuum valve 176a to selectively connect a chamber 128a of the first pre-conditioning vessel to vacuum source 156. Second pre-conditioning vessel 108b can include a second vacuum valve 176b to selectively connect a chamber 128b of the second pre-conditioning vessel to vacuum source 156.

Each of first and second pre-conditioning vessels 108a, 108b are controllable to discharge bulk material to second transfer section 148. For example, first pre-conditioning vessel 108a is configured to discharge bulk material to a first passage 152a of second transfer section 148 and second pre-conditioning vessel 108b is configured to discharge bulk material to a second passage 152b of the second transfer section. First and second passages 152a, 152b of second transfer section 148 are in communication with chamber 144 of freeze drying vessel 112 and configured to deliver bulk material from the pre-conditioning vessel to the freeze drying vessel (e.g., to a rotary drum thereof). As depicted in FIG. 3A, second transfer section 148 can include or be coupled to a transfer flap 204 that is configured to selectively connect the second transfer section to freeze drying vessel 112. Transfer flap 204 can operate similarly to transfer flap 192, except that the transfer flap 204 operates as a flow combiner and transfer flap 192 operates as a flow splitter. In other configurations, one or more valves (e.g., 152—FIG. 2) can be used in addition to or in place of transfer flap 192 to control flow of the bulk material or atmospheric conditions within second transfer section 148 or freeze drying vessel 112.

System 100a can be operated to freeze dry a bulk product, and, in some configurations, controller 116 can be configured to actuate one or more components (e.g., pre-conditioning vessels 108a, 108b; freeze drying vessel 112; valves 140, 152, 175; vacuum sources 156a, 156b; liquid source 180; transfer flaps 192, 204, or the like) of the system to perform the operations described herein. As an illustrative example, a plurality of droplets 188 can be generated within spray freezing vessel 104 and delivered to first pre-conditioning vessel 108a. In some configurations, accumulated ice particles within spray freezing vessel 104 can be transferred with droplets 188 as bulk material that can exhibit poor flow characteristics. During delivery of droplets 188 to first pre-conditioning vessel 108a, both spray freezing vessel 104 and first pre-conditioning vessel can operate at atmospheric conditions.

After a first portion of bulk material is transferred to first pre-conditioning vessel 108a, transfer flap 192 may be actuated (e.g., from the first position to the second position) to deliver bulk material (e.g., a second portion) to second pre-conditioning vessel 108b. Actuation of transfer flap 192 (or valves 140) can be based on an input associated with one or more values or measurements transmitted by sensors (e.g., fill level of pre-conditioning vessel, duration, or the like), one or more thresholds, other historical or predictive data, or the like. Additional bulk material may then be delivered to second pre-conditioning vessel 108b, and first pre-conditioning vessel 108a may be operated to decrease a concentration of ice particles within the first portion of the bulk material. In some configurations, first pre-conditioning vessel 108a may be sealed from spray freezing vessel 104 and operated under vacuum conditions (e.g., less than 100 μbar), at a target temperature range (e.g., from −50° C. to −20° C.), a target rotational mode (e.g., pendular mode), or a combination thereof. First pre-conditioning vessel 108a can be operated until desired flow properties of the first portion of bulk material are achieved. As an illustrative, non-limiting example, until an amount of ice particles in the first portion of the bulk material is reduced by at least five percent, such as 10, 20, 25, 30, 40, 50, 60, 70, or 75%. First pre-conditioning vessel 108a may then discharge the bulk material (having a decreased concentration of ice particles) to freeze drying vessel 112, where the droplets 188 can be freeze dried. Freeze drying vessel 112 can be operated at the same or different operational parameters to freeze dry the bulk material. For example, in some configurations, first pre-conditioning vessel 108a and freeze drying vessel 112 can include operational pressures that are substantially equal. In this way and others, the bulk material within freeze drying vessel 112 can have improved flow properties as compared to the flow properties achievable with conventional processes, and the risk of clogging, spillage, or diminished freeze drying properties can be reduced.

In some aspects, after the first portion of bulk material is discharged from first pre-conditioning vessel 108a to freeze drying vessel 112, transfer flap 192 may be actuated (e.g., from the second position to the first position) to deliver bulk material to the first pre-conditioning vessel. Additional bulk material (e.g., a third portion) may then be delivered to first pre-conditioning vessel 108a, and second pre-conditioning vessel 108b may be operated to decrease a concentration of ice particles within the second portion of the bulk material therein. Second pre-conditioning vessel 108b can be operated in a similar manner to first pre-conditioning vessel 108a until desired flow properties of the second portion of bulk material are achieved.

Second pre-conditioning vessel 108b can then discharge the second portion of bulk material and subsequently receive additional bulk material (e.g., fourth portion). This operation of first and second pre-conditioning vessel 108a, 108b can be repeated until a target amount of liquid product is freeze dried. Accordingly, as explained herein, system 100a can provide an improved continuous lyophilization process.

Referring now to FIG. 4, a method 400 of producing of freeze-dried particles under aseptic conditions is shown. In some configurations, method 400 is performed by or at one of system 100, 100a. Although the example method 400 is described with reference to the flowchart illustrated in FIG. 4, it will be appreciated that other ways of performing the acts associated with the method 400 may be used in view of the preceding description.

As shown, method 400 includes forming a bulk material having frozen pellets (e.g., 188) and ice particles in a spray freezing vessel (e.g., 104), at step 402. In some configurations, forming the bulk material can include actuating liquid source 180 to deliver the liquid droplets (e.g., 188) to spray freezing vessel 104, maintaining a temperature of spray freezing vessel 104 to freeze droplet 188, delivering the frozen droplets to at least one of the pre-conditioning vessels, or a combination thereof. In some configurations, bulk material may consist of, or consist essentially of, frozen droplets and ice particles.

Method 400 further includes transferring a first portion of the bulk material to a first pre-conditioning vessel (e.g., 108a), at step 404. In some configurations, the transferring can include actuating one or more first transfer valve(s) 140, transfer flap 192, or both, to the first position to deliver a first portion of the bulk material to first pre-conditioning vessel 108a. The bulk material can be delivered to first pre-conditioning vessel 108a until one or more conditions occur, such as receiving an input at controller 116. In some configurations, the first portion of the bulk material is transferred to first pre-conditioning vessel 108a via first transfer section 136.

Method 400 further includes operating the first pre-conditioning vessel (e.g., 108a) in a first state to remove ice particles from the first portion of the bulk material, at step 406. In some configurations, operating in the first state can include sealing first pre-conditioning vessel 108a from spray freezing vessel 104, operating the first pre-conditioning vessel under vacuum conditions (e.g., via actuation of vacuum source or vacuum valve), operating rotary drum 132 of the first pre-conditioning vessel in a pendular mode, or a combination thereof. Additionally, or alternatively, operating in the first state can be performed for a target duration (e.g., from twenty to eighty minutes), until flow properties of the bulk material are improved (e.g., an amount of ice particles being less than a threshold amount), or the like. In some configurations, an amount of ice particles in the first portion of the bulk material is reduced more than 20 percent (e.g., by volume or by mass) by operating the first pre-conditioning vessel in the first state, such as by 25, 30, 40, 50 percent, or more. In at least some of the present methods, the first pre-conditioning vessel (e.g., 108a) can be in constant motion while the first portion of the frozen bulk material is disposed therein. In this way and others, the bulk material can be constantly under motion after formation and until the freeze-drying operation begins.

Method 400 further includes transferring the first portion of the bulk material from the first pre-conditioning vessel (e.g., 108a) to a freeze drying vessel (e.g., 112), at step 408. In some configurations, the transferring can include operating first pre-conditioning vessel 108a in a discharge mode or actuating transfer valve(s) 152, transfer flap 204, or both, to deliver the first portion of the bulk material to freeze drying vessel 112. The first portion of the bulk material may be transferred to freeze drying vessel 112 via second transfer section 148. In some configurations, each of first pre-conditioning vessel 108a and freeze drying vessel 112 may maintain vacuum conditions during the transfer.

Method 400 further includes operating the freeze drying vessel (e.g., 112) in a second state to freeze-dry the first portion of the bulk material, at step 410. In some configurations, the freeze drying step may remove any remaining ice particles such that only the frozen droplets 21 remain to be freeze dried. One or more parameters of freeze drying vessel 112 (e.g., pressure, temperature, such as drum temperature or infrared heater power, humidity, rotation speed, or the like) in the second state can be the same or different than the parameters of first pre-conditioning vessel 108a in the first state. For example, a pressure of freeze drying vessel 112 in the second state can be within 15 percent of (e.g., within 10, 5, or 3 percent of) a pressure of first pre-conditioning vessel 108a in the first state. In some configurations, the physical separation of freeze drying vessel 112 and first pre-conditioning vessel 108a can, among other things, result in the freeze drying vessel being operated at more progressive parameters. As a non-limiting example, a rotation speed of drum 132, a temperature of a surface of the drum, an output of the infrared heater, or a combination thereof, is higher than a corresponding parameter in first pre-conditioning vessel 108a. Although method 400 includes each of the steps listed above, it should be understood that other methods of the present disclosure can different groups of steps, including or omitting some of the steps of the method shown in FIG. 4.

Referring now to FIG. 5, a method 500 of producing of freeze-dried particles under aseptic conditions is shown. In some configurations, method 500 is performed by or at one of system 100, 100a. Although the example method 500 is described with reference to the flowchart illustrated in FIG. 5, it will be appreciated that other ways of performing the acts associated with the method 500 may be used in view of the preceding description.

As shown, method 500 includes forming a bulk material in a spray freezing vessel (e.g., 104), at step 502. Method 500 further includes transferring a portion of the bulk material to a first pre-conditioning vessel (e.g., 108a), at step 504. Steps 502 and 504 may include or correspond to steps 402 and 404, respectively, of FIG. 4.

Method 500 further includes operating the first pre-conditioning vessel (e.g., 108a) in a first state, at step 506, and transferring a portion of the bulk material to a second pre-conditioning vessel (e.g., 108a), at step 508. Operating first pre-conditioning vessel 108a in the first state, at step 506, may include or correspond to step 406 of FIG. 4. The operating and transferring steps can occur concurrently such that at least a portion of the operation of first pre-conditioning vessel 108a in the first state occurs while bulk material is delivered to second pre-conditioning vessel 108b. In some configurations, steps 506 or 508 includes actuating transfer valve(s) 140, transfer flap 192, or both, to the second position to seal chamber 120 of spray freezing vessel 104 from chamber 128a of first pre-conditioning vessel 108a and guide a second portion of the bulk material to second pre-conditioning vessel 108b. In some such configurations, second pre-conditioning vessel 108b can remain at atmospheric pressure while first pre-conditioning vessel 108a operates under vacuum conditions. In an illustrative example, first vacuum valve 176a can operate in an open state such that chamber 128a is in communication with vacuum source 156a and second vacuum valve 176b can operate in a closed state such that chamber 128a is not in communication with vacuum source 156a. In some configurations, operating first pre-conditioning vessel 108a and transferring the bulk material to second pre-conditioning vessel 108b may begin at substantially the same time (e.g., within 1, 3, or 5 minutes) or be performed for substantially the same amount of time (e.g., having durations within 1, 5, or 10% of one another). As an illustrative example, operating the first pre-conditioning vessel in the first state is performed for thirty to sixty minutes.

Method 500 further includes transferring the bulk material to a freeze drying vessel (e.g., 112), at step 510, and operating the second pre-conditioning vessel (e.g., 108b) in a first state, at step 512. Transferring the bulk material to freeze drying vessel 112, at step 506, may include or correspond to step 410 of FIG. 4. Operating second pre-conditioning vessel 108b in the first state, at step 512, may include or correspond to step 406 of FIG. 4. In some configurations, the operating and transferring steps can occur concurrently. However, in other configurations, transferring the bulk material to freeze drying vessel 112, at step 510, may occur before the operating step, at 512. For example, transferring the bulk material to freeze drying vessel 112, at step 510, may occur concurrently with step 508. In some such configurations, the operating step, at 512, may occur concurrently with an additional transferring step (e.g., 504) in which the bulk material is transferred to first pre-conditioning vessel 108a for a second time.

Method 500 further includes transferring the bulk material to a freeze drying vessel (e.g., 112), at step 514. Transferring the bulk material to freeze drying vessel 112, at step 514, may include or correspond to step 410 of FIG. 4. In some configurations, first and second pre-conditioning vessels 108a, 108b are operated to process a continuous stream of frozen droplets 188 from spray freezing vessel 104, to deliver a continuous stream of bulk material to freeze drying vessel 112, or both. For example, transferring the first portion of the bulk material from first pre-conditioning vessel 108a to the freeze drying vessel 112 can be performed during a first time period and transferring the second portion of the bulk material from the second pre-conditioning vessel 108b to the freeze drying vessel is performed during a second time period that is within 10 minutes of the first time period, such as within 8, 5, 3, 2 or 1 minute(s). In some of the above configurations, at least one of the pre-conditioning vessels (e.g., 108) can be continuously receiving product; afterward, each pre-conditioning vessel may then be sealed, operated in a pre-conditioning state for a first period, and discharged during a discharge period. For example, drum (e.g., 132) can be controlled to reverse rotation direction and discharge (e.g., via one or more scoops within the drum, as is known in the art) material at a certain point during each rotation. This discharge process can continuously discharge a portion of the material for the discharge period (e.g., five to thirty minutes) until no material, or substantially no material, remains within the drum and, more broadly, the pre-conditioning vessel. Each of system 100, 100a, described herein, can be operated such that the discharge period of each pre-conditioning vessels can occur at a high frequency and pre-conditioned product is delivered to the freeze drying step (e.g., 112) with few or brief breaks in between.

Although, method 500 is described for two pre-conditioning vessels (e.g., 108), it should be understood that such methods can be performed in systems having three or more pre-conditioning vessels. Further, it should be understood that other methods of the present disclosure can steps, including or omitting some of the steps of the method shown in FIG. 5. Moreover, in other embodiments of the present systems, and methods, multiple process lines represented by the components of system 100 shown in FIG. 1 may be running in parallel and under the control of a common control system, like controller 116.

The above specification and examples provide a complete description of the structure and use of illustrative configurations. Although certain configurations have been described above with a certain degree of particularity, or with reference to one or more individual configurations, those skilled in the art could make numerous alterations to the disclosed configurations without departing from the scope of this invention. As such, the various illustrative configurations of the methods and systems are not intended to be limited to the particular forms disclosed. Rather, they include all modifications and alternatives falling within the scope of the claims, and configurations other than the one shown may include some or all of the features of the depicted configurations. For example, elements may be omitted or combined as a unitary structure, connections may be substituted, or both. Further, where appropriate, aspects of any of the examples described above may be combined with aspects of any of the other examples described to form further examples having comparable or different properties or functions, and addressing the same or different problems. Similarly, it will be understood that the benefits and advantages described above may relate to one configuration or may relate to several configurations. Accordingly, no single implementation described herein should be construed as limiting and implementations of the disclosure may be suitably combined without departing from the teachings of the disclosure.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

The claims are not intended to include, and should not be interpreted to include, means-plus- or step-plus-function limitations, unless such a limitation is explicitly recited in a given claim using the phrase(s) “means for” or “step for,” respectively.

1. A freeze drying system for freeze drying a bulk product, comprising:
a spray freezing vessel configured to freeze liquid droplets to form bulk material,
one or more pre-conditioning vessels configured to receive bulk material from the spray freezing vessel, each of the pre-conditioning vessel(s) coupled to a vacuum source and including:
a container controllable to move while bulk material is in the pre-conditioning vessel(s); and
a heater configured to increase or decrease a temperature of the container; and
a freeze drying vessel configured to receive the bulk material from the pre-conditioning vessel(s), the freeze drying vessel configured to freeze-dry the bulk material therein.

2. The freeze drying system of claim 1, wherein each pre-conditioning vessel is coupled to the spray freezing vessel via a transfer section that can be opened or closed to allow or not allow bulk material to travel from the spray freezing vessel to that pre-conditioning vessel.

3. The freeze drying system of any of claims 1-2, wherein:
the container includes a rotary drum;
each of the one or more pre-conditioning vessel(s) includes:
a vacuum chamber coupled to the vacuum source; and
a heater positioned outside the drum and at least partially inside the vacuum chamber; and
wherein the drum of each pre-conditioning vessel is positioned inside the vacuum chamber of that pre-conditioning vessel and is controllable to move in a pendular mode while bulk material is in the drum.

4. The freeze drying system of claim 3, wherein the pendular mode does not include a complete rotation of the drum.

5. The freeze drying system any of claims 3-5, wherein the drum of each pre-conditioning vessel is also controllable to rotate to discharge bulk material from that drum.

6. The freeze drying system of any of claims 1-5, wherein the freeze drying vessel is coupled to a second vacuum source, and the freeze drying vessel includes:
a freeze drying vessel drum configured to receive bulk material from each pre-conditioning vessel; and
a freeze drying vessel heater configured to transfer heat to or from bulk material within the freeze drying vessel drum.

7. The freeze drying system of any of claims 1-6, further comprising a controller having a processor and a memory coupled to the processor and configured to store instructions that, when executed by the processor, cause the controller to:
determine a time period in which bulk material is within a first pre-conditioning vessel of the one or more pre-conditioning vessel(s); and
based on the time period meeting a first threshold, actuate the first pre-conditioning vessel to transfer bulk material to the freeze drying vessel.

8. The freeze drying system of any of claims 1-6, wherein the one or more pre-conditioning vessel(s) include:
a first pre-conditioning vessel configured to receive bulk material from the spray freezing vessel; and
a second pre-conditioning vessel configured to receive bulk material from the spray freezing vessel.

9. The freeze drying system of claim 8, further comprising one or more transfer valve(s) coupled to the spray freezing vessel, the one or more transfer valve(s) configurable in:
a first position in which bulk material is configured to flow from the spray freezing vessel to the first pre-conditioning vessel; and
a second position in which bulk material is configured to flow from the spray freezing vessel to the second pre-conditioning vessel.

10. The freeze drying system of claim 9, further comprising a controller having a processor that can execute instructions that cause the controller to:
actuate a liquid source to deliver the liquid droplets to the spray freezing vessel;
actuate the one or more transfer valve(s) to the first position to deliver a first portion of the bulk material to the first pre-conditioning vessel; and
based on a first input:
actuate the one or more transfer valve(s) to the second position to deliver a second portion of the bulk material to the second pre-conditioning vessel;
seal the first pre-conditioning vessel from the spray freezing vessel; and
operate the first pre-conditioning vessel in a first state to remove ice particles from the first portion of the bulk material.

11. The freeze drying system of claim 10, wherein the instructions, when executed by the processor, further cause the controller, while the first pre-conditioning vessel is in the first state, to:
actuate the vacuum source to decrease a pressure in the first pre-conditioning vessel to less than 50 microbar; and
actuate the drum of the first pre-conditioning vessel to operate in a pendular mode.

12. The freeze drying system of any of claims 10-11, wherein the instructions, when executed by the processor, further cause the controller to:
determine a duration of the first pre-conditioning vessel operating in the first state; and
based on the duration meeting a first threshold,
actuate the first pre-conditioning vessel to discharge the first portion of the bulk material to the freeze drying vessel;
actuate the one or more transfer valve(s) to the first position to deliver a third portion of the bulk material to the first pre-conditioning vessel; and
operate the second pre-conditioning vessel in the first state to remove ice particles from the second portion of the bulk material.

13. A method of producing of freeze-dried particles under aseptic conditions, the method comprising:
forming, in a spray freezing vessel, a bulk material having frozen pellets and ice particles;
transferring a first portion of the bulk material to a first pre-conditioning vessel;
operating the first pre-conditioning vessel in a first state to remove ice particles from the first portion of the bulk material;
transferring the first portion of the bulk material from the first pre-conditioning vessel to a freeze drying vessel; and
operating the freeze drying vessel in a second state to freeze-dry the first portion of the bulk material.

14. The method of claim 13, wherein the operating the first pre-conditioning vessel in the first state includes:
sealing the first pre-conditioning vessel from the spray freezing vessel;
operating the first pre-conditioning vessel under a vacuum; and
operating a drum of the first pre-conditioning vessel in a pendular mode.

15. The method of any of claims 13-14, further comprising:
transferring a second portion of the bulk material to a second pre-conditioning vessel;
operating the second pre-conditioning vessel in a third state to remove ice particles from the second portion of the bulk material;
transferring the second portion of the bulk material from the second pre-conditioning vessel to the freeze drying vessel; and
operating the freeze drying vessel in the second state to freeze-dry the second portion of the bulk material.

16. The method of claim 15, wherein the operating the first pre-conditioning vessel in the first state and the transferring the second portion of the bulk material to the second pre-conditioning vessel occur concurrently.

17. The method of claim 15, further comprising, after the transferring the first portion of the bulk material from the first pre-conditioning vessel to the freeze drying vessel and after the transferring the second portion of the bulk material to the second pre-conditioning vessel:
transferring a third portion of the bulk material to the first pre-conditioning vessel;
operating the first pre-conditioning vessel in the first state to remove ice particles from the third portion of the bulk material;
transferring the third portion of the bulk material from the first pre-conditioning vessel to the freeze drying vessel; and
operating the freeze drying vessel to freeze-dry the third portion of the bulk material.

18. The method of any of claims 15-17, wherein:
the transferring the first portion of the bulk material from the first pre-conditioning vessel to the freeze drying vessel is performed during a first time period;
transferring the second portion of the bulk material from the second pre-conditioning vessel to the freeze drying vessel is performed during a second time period; and
the second time period is within three minutes of the first time period.

19. The method of any of claims 13-18, wherein operating the first pre-conditioning vessel in the first state is performed for thirty to sixty minutes.

20. The method of any of claims 13-19, wherein an amount of ice particles in the first portion of the bulk material is reduced by fifty percent by the operating the first pre-conditioning vessel in the first state.
